(19) United States
(12) Patent Application Publication
(10) Pub. No.: US 2018/0182042 A1
(43) Pub. Date: Jun. 28, 2018

(54) SYSTEMS AND METHODS FOR ESTIMATING TRANSACTION RATES

(71) Applicant: American Express Travel Related Services Company, Inc., New York, NY (US)

(72) Inventor: Vishwa Vinay, Bangalore (IN)

(73) Assignee: American Express Travel Related Services Company, Inc., New York, NY (US)

(21) Appl. No.: 15/387,912

(22) Filed: Dec. 22, 2016

(51) Int. Cl. G06Q 40/00

(52) U.S. Cl. CPC G06Q 40/12

(57) ABSTRACT

A transaction rate estimate system may retrieve an earlier transaction rate estimate along with a new set of transaction data. The new set of transaction data may include a new transaction count and a new time period over which the new transaction count occurred. The system may process the retrieved data by estimating a new transaction rate using a conjugate prior pair with the first transaction rate estimate, the new transaction count, and the new time period as inputs. The system may also store the new transaction rate for use in future estimates and present applications.

### FIELD

The present disclosure relates to estimating transaction rates for charge accounts.

### BACKGROUND

Companies providing credit accounts, checking accounts, or other transaction accounts to facilitate purchase transactions typically monitor the accounts closely. The transaction account providers may be interested to know where an account holder is spending, how much they are spending, and/or how often they are spending to detect fraud, for example. Data such as the transaction rate (i.e., number of transactions per unit time) may be of interest. For example, a transaction account provider may be interested in the number of transactions that occurred at a merchant over the course of a year. To calculate that transaction rate, providers may count all transactions that occurred at that merchant over the year and divide the count by 365 to arrive at an average number of transactions per day.

Calculating transaction rate as an average yields data with undesirable characteristics for some applications. If the transaction rate has changed abruptly for the merchant, then the above described average will not capture the sudden change in a meaningful way. For example, if the merchant has become twice as popular over the last 10 days, the 10-day period would be dominated by the much longer year-long period. The burst in popularity may only appear as a fractional increase in transactions per day over the year.

Providers may attempt to use a weighting function to add importance to more recent data. However, the approach of using a specific weighting function can be ad hoc. The ideal weighting function for a particular application or account may vary greatly from various applications or accounts. The ideal weighting function may even vary from day to day.

Moreover, calculating averages and weighting functions both depend on historic data. In order to count transactions over a large time period, one must track the transactions over the time period and store the corresponding data to support future calculations. For the sliding window average techniques, transaction data may take up large amounts of data storage space, especially in light of the number of transactions occurring daily across all accounts.

### SUMMARY

A system, method, and computer readable medium (collectively, the “system”) is disclosed for estimating transaction rates. In various embodiments, the system may retrieve an earlier transaction rate estimate along with a new set of transaction data. The new set of transaction data may include a new transaction count and a new time period over which the new transaction count occurred. The system may process the retrieved data by estimating a new transaction rate using a conjugate prior pair with the first transaction rate estimate, the new transaction count, and the new time period as inputs. The system may also store the new transaction rate for use in future estimates and present applications.

In various embodiments, the conjugate prior pair may be a Poisson-gamma conjugate prior pair or a negative binomial-beta conjugate prior pair. The system may also generate an initial transaction rate estimate, retrieve an initial set of transaction data over an initial time period, and generate the above earlier transaction rate estimate using the conjugate prior pair with the initial transaction rate estimate, the initial set of transaction data, and the initial time period as inputs. The system may discard the new set of transaction data in response to the estimating the new transaction rate estimate since the new transaction rate estimate includes analysis of all earlier historical transaction data used to generate an estimate. The transaction rate estimate system may use the conjugate prior pair with a forgetting factor of approximately 1, or a forgetting factor ranging from 0.5 to 10. The forgetting factor may be selected as any number greater than (or equal to) zero. The system may also estimate a second new transaction rate using the conjugate prior pair with the earlier transaction rate estimate, another new transaction count, and another new time period as inputs. The system may discard the earlier transaction rate estimate in response to estimating the second new transaction rate.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

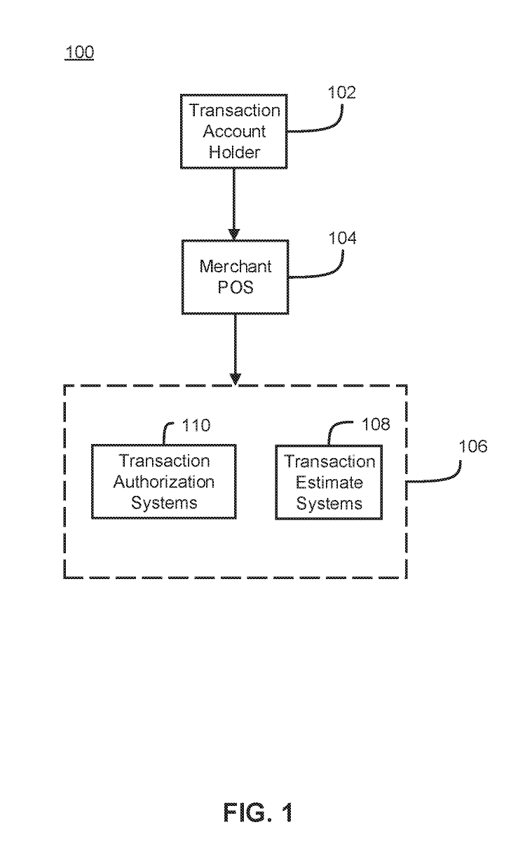

FIG. 1 illustrates a system for collecting and storing transaction data and estimating transaction rates from the collected data, in accordance with various embodiments;

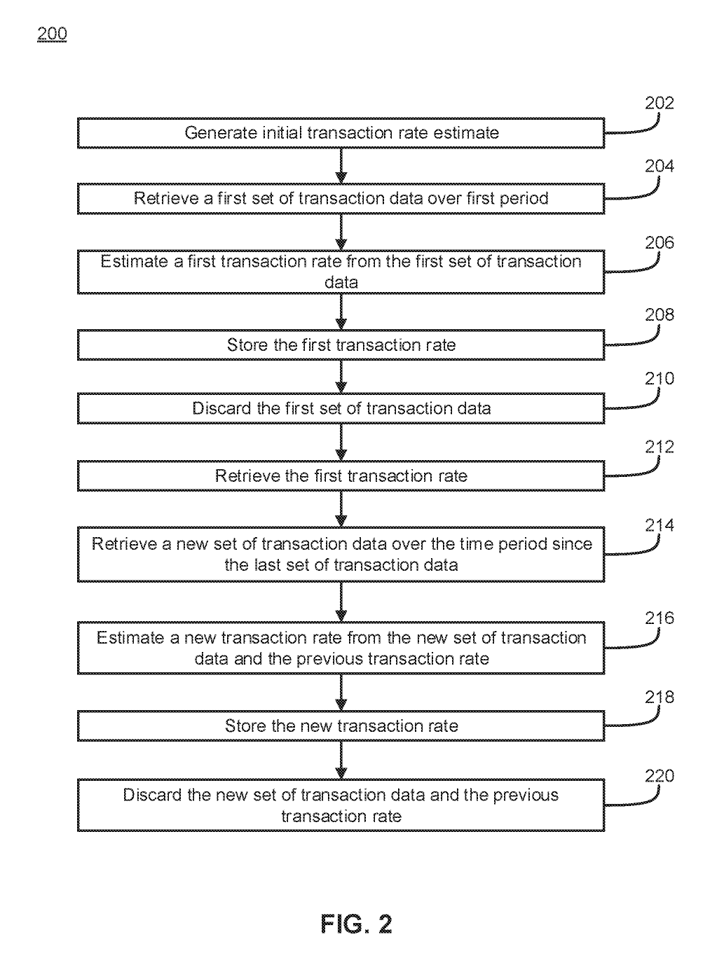

FIG. 2 illustrates a process for estimating transaction rates using transaction data and previous transaction rate estimations, in accordance with various embodiments;

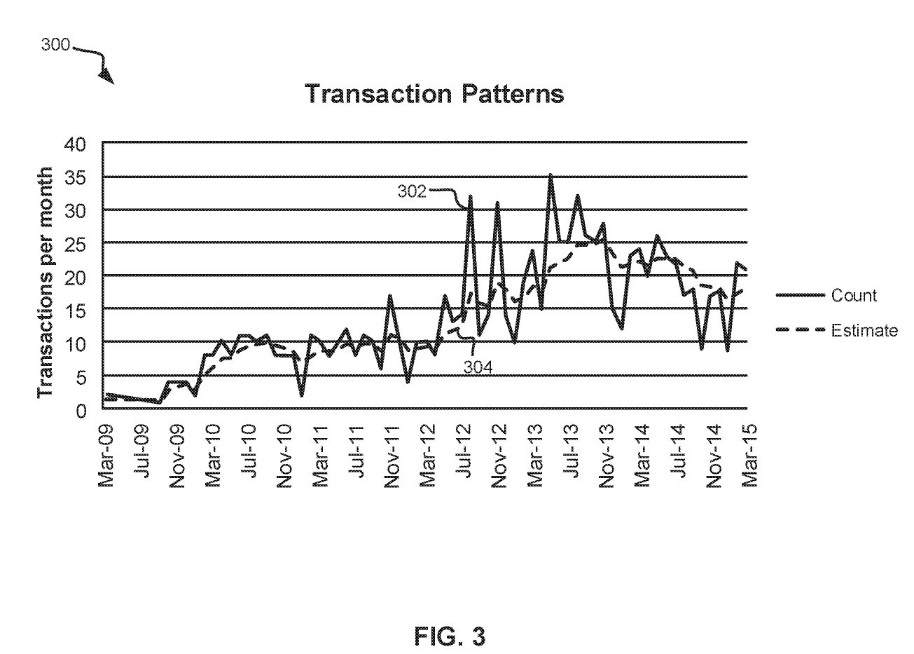

FIG. 3 illustrates a graph comparing actual transaction counts over various periods compared to the transaction rate estimates made from the various transaction counts and periods, in accordance with various embodiments; and

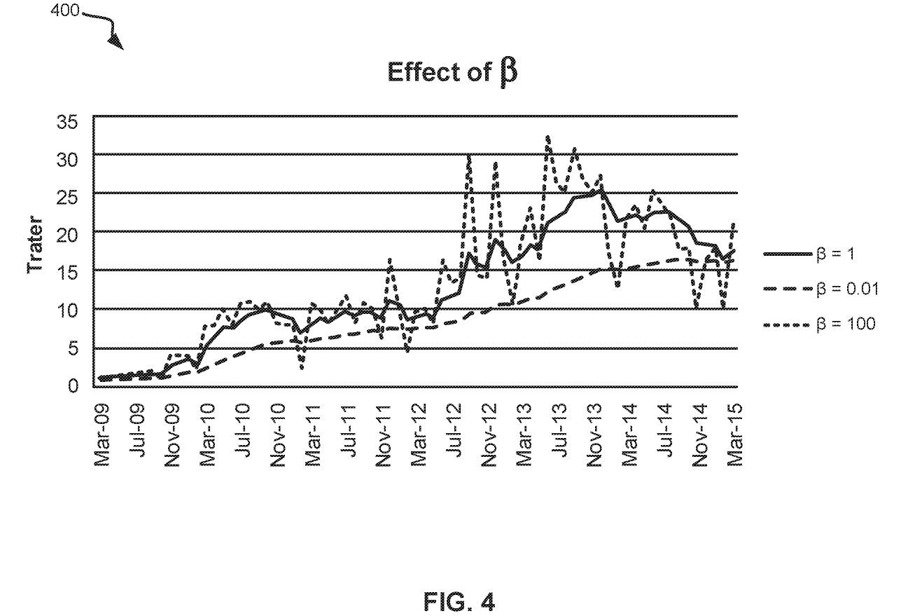

FIG. 4 illustrates the effect of varying a forgetting factor in a transaction rate estimation process, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The present disclosure provides a system, method, and computer program product for estimating transaction rates based on historical transactional data collected at points of sale. The system may count historical transactions for an account, market segment, account holder, account holder/merchant combinations, or other logical entities. The system may estimate the historical transaction rates for the entities based on the transaction data. The estimated historical transaction rate has historic data rolled into the estimation so that historic transaction data need not be saved nor looked up to make a new estimate in the future. The transaction estimation systems speed up the estimation process and drastically reduce storage space occupied by historic transaction data for transaction rate purposes. As a result, estimates may be completed more frequently with less processing and storage resources.

Referring to FIG. 1, system 100 for collecting transaction data and estimating transaction rates is shown, in accordance with various embodiments. System 100 includes transaction rate estimate systems 108 that estimate transaction rates for various logical entities. Logical entities may be any grouping of transacting entities such as, for example, a market segment, an account holder, a grouping of account holders, a merchant, a grouping of merchants, and/or an account holder with a merchant, for example. Any logical grouping of transacting entities may have a transaction rate. Transaction rate estimate systems 108 may be maintained by a financial institution 106 that has access to historical transaction data. The historical transaction data may he closed loop data collected from records of charge (ROCs) for each transaction.

Transaction account holder 102 may have a transaction account with the financial institution 106, for example. The transaction account holder may use the transaction account to purchase items at merchant POS 104. Merchant POS 104 may include an in-store point of sale, an online point of sale, a portable device having transaction capabilities (e.g., a smartphone or tablet), or any other computing device that communicates with financial institution 106 to complete transactions. Transaction authorization systems 110 of financial institutions may approve or decline the various transaction requests received from merchant POS 104. As a result, financial institution 106 may maintain a historical record of transactions suitable for use in estimating transactions rates. The historical record of transactions may he used to seed the estimation systems. The transaction historical record of the present estimation system may also be seeded by using a transaction count from a single time period, as described in greater detail herein.

Transaction rate estimate systems 108 may take the form of a computer or processor, or a set of computers/processors, although other types of computing units or systems may be used, including servers, mainframes, computing clusters. Less powerful computing devices may also be used for small scale transaction rate estimate systems such as, for example, laptops, notebooks, hand held computers, personal digital assistants, cellular phones, smart phones e.g., iPhone®, BlackBerry®, Android®, etc.) tablets, wearables smart watches and smart glasses), or any other device capable of estimating transaction rates as described herein.

In various embodiments, transaction rate estimate systems 108 may calculate a quantity representing the rate of transactions (e.g., number of transactions per unit time) for each merchant/account holder combination. Transaction rate estimate systems 108 may respond to changes (e.g. a merchant becoming popular) by reflecting the changes in the rate estimate. Transaction rate estimate systems 108 may trigger responses to changes in transaction rate (e.g., promote trending merchants). Negative changes in transaction rate are also possible and may be of interest. Transaction rate estimate system 108 may also maintain a running estimate of the transaction rate, one per merchant/account holder, and a regular process (e.g. runs once per day) consumes transaction information to revise the rate estimates. Thus, transaction rate estimate systems may update the transaction estimates using only transaction event information since the last update. Transaction rate estimate system 108 has increased data efficiency over transaction rate calculations that rely on historical data.

Referring now to FIG. 2, a process 200 for estimating transaction rate on transaction rate estimate systems 108 is shown, in accordance with various embodiments. Transaction rate estimate systems 108 may trace the trajectory of the estimated transaction rates, representing “transactions per month” for a given merchant, to identify merchants with a decreasing trend in their transaction rate for further review.

Transaction rate estimate systems 108 may characterize each merchant/account holder based on a conjugate prior pair using a Poisson of rate λ (i.e., λ is the estimated transaction rate) and a gamma distribution (i.e., a Poisson-gamma conjugate prior pair). Transaction systems may generate an initial transaction rate estimate (Block 202). The initial values (e.g. for a new account holder/merchant combination, or for another logical entity) may be chosen based on a global average. The initial value may also be calculated one time using historic data prior to discarding the historic data. The term discard as used with historic data means the historic data may be moved to archives, deleted, stored off-site on magnetic tape, and/or otherwise removed from more costly fast-access configurations. In that regard, the initial transaction rate estimate may be an actual transaction rate calculation over a period of interest. The initial values occur at time t₀ and result in the initial estimation λ₀, which is not necessarily estimated using the estimation processes discussed herein.

Transaction rate estimate systems 108 may retrieve a first set of transaction data (i.e., events c) over a time period τ (Block 204). The set of transaction data may include a count of transaction events c, or a set of data that is countable to generate a count of transaction events c. The set of transaction data may be data relating to transactions only taking place during period τ rather than before or after. The period τ may be defined as the time period from the previous time period end time (tₙ) to the current time period end time (tₙ₊₁) and is the time period spanning from t₀ to t₁ for the initializing estimate.

Transaction rate estimate systems 108 may estimate a first transaction rate from the first set of transaction data and the initial transaction rate estimate (Block 206). A gamma distribution may be used as the prior for rate (λ) using new transaction events to obtain an updated value that would also be described by a gamma (Γ), as shown in equation 1.

(λ; a, b)=Γ(λ, a,b) (1)

The mean and variance of a gamma may be represented as

$$μ = \frac{a}{b} and {σ}^{2} = \frac{a}{{b}^{2}} ,$$

respectively.
Given observations in the form of transaction events (e.g. c events in τ time period), an updated rate can be obtained as follows working from equation 2 to equation 5:

$$\begin{matrix}{}_{0} ( λ ; {a}_{0} , {b}_{0} ) = Γ ( λ ; {a}_{0} , {b}_{0} ) & ( 2 ) \\ {}_{1} ( λ ; {a}_{1} , {b}_{1} ) = Γ ( λ ; {\hat{a}}_{0} + c , {\hat{b}}_{0} + τ ) & ( 3 ) \\ {\hat{a}}_{0} = δ {a}_{0} and {\hat{b}}_{0} = δ {b}_{0} & ( 4 ) \\ δ = \frac{{σ}_{0}^{2}}{{σ}_{0}^{2} + β τ} & ( 5 )\end{matrix}$$

where σ₀² is the current variance, and β is a forgetting factor described below. Transaction rate estimate systems 108 may update from ₀(λ; a₀, b₀) to ₁(λ; a₁, b₁). The update may happen in two steps described as nosing and observations. Nosing describes the two gamma. distributions given by Γ(λ; a₀, b₀) and Γ(λ; â₀, \hat{b}₀) have the same mean

$$μ = \frac{{a}_{0}}{{b}_{0}} = \frac{{\hat{a}}_{0}}{{\hat{b}}_{0}} .$$

The gamma distributions also have different variances:

$${σ}_{{0}^{2}} = \frac{{a}_{0}}{{b}_{0}^{2}} ,$$

while

$${σ}_{1}^{2} = \frac{{\hat{a}}_{0}}{{\hat{b}}_{0}^{2}} = \frac{{σ}_{0}^{2}}{δ} .$$

That is, if δ<1, the variance has increased. The magnitude of this increase is controlled by the forgetting factor β introduced above in equation 5. in response to the noised-up gamma distribution Γ(λ; â₀, \hat{b}₀), transaction rate estimate systems 108 may use the observations (c events in τ time periods) to provide Γ(λ; â₀+c, \hat{b}₀+τ).

The parameter β may be set to a large number in transaction rate estimate systems 108 to configure new observations as having a larger influence on the updated gamma. The new mean of the rate may be given by

$$μ = \frac{δ {a}_{0} + c}{δ {b}_{0} + {β}_{τ}} .$$

Since ₁(λ; a₁, b₁)=Γ(λ; â₀+c, \hat{b}₀+τ) is a gamma distribution, it can be used as the prior for calculating p₂(λ; a₂, b₂) using the same process as above. Transaction estimate system may generally update the estimate from the previous time period (t) to time period (t+1) by maintain the corresponding (aₜ, bₜ) and performing the above analysis. In response to retrieving the first set of transaction data including the count, c, transaction rate estimate system 108 may calculate (aₜ₊₁, bₜ₊₁).

In various embodiments, transaction rate estimate systems 108 may store the estimate transaction rate for later access (Block 208). The estimated transaction rate may be a single number indicative of all previously estimated transaction history as well as current transaction history from the first period just considered in the steps of block 206. The estimated transaction rate may be stored in a data storage system configured for fast retrieval. For example, the transaction rate may be stored in an indexed table in a relational database management system. The transaction rate may also be stored in a distributed computing cluster such as those used to support big data systems.

In various embodiments, transaction rate estimate systems 108 may discard the set of transaction data used in the estimation steps of block 206 (Block 210). As described above, discarding may include moving the transaction data into slower access data storage. Transaction rate estimate systems 108 can continue making future estimates that inherently take into consideration the previous transaction data without accessing the previously used transaction data.

In various embodiments, transaction rate estimate system 108 may retrieve the first transaction rate (Block 212). The first transaction rate may be used in subsequent estimate operations. Since the first transaction rate is estimated by applying the above techniques to the initial transaction rate estimate (λ₀) and the first estimated transaction rate (λ₀₊₁), the first transaction rate estimate has previous transaction date rolled in. Transaction rate estimate system 108 may also retrieve a second set of transaction data over a second period (Block 214). The second period may span the time that has elapsed since the pervious time period ended. In that regard, the second set of transaction data may contain data and/or a count from all transaction occurring from the end of the previous time period until the next time of interest (e.g., t₂).

Transaction rate estimate systems 108 may estimate a new transaction rate from the new set of transaction data (e.g., count cₙ) and the previous transaction rate (Block 216). The new transaction rate may be recursively calculated as λₙ₊₁. For the second data set, the estimated transaction rate is λ₂. The new transaction rate estimate (λ₂) may be calculated using the above processes as applied for a time period r spanning from tₙ to tₙ₊₁ along with the corresponding transaction event count c.

In various embodiments, transaction rate estimate systems 108 may store the newly estimated transaction rate (λₙ₊₁) for later retrieval and estimation (Block 218). Transaction rate estimate systems 108 (e.g., count cₙ) may also discard the new set of transaction data and the previous transaction rate (λₙ) as described above (Block 220). The rate estimate (λ) may be updated at any time by repeating one or more of the steps associated with blocks 212 through 220. Process 200 recursively calculates a current transaction rate estimate from the previous transaction rate estimate and transaction data accumulating in a time period since the previous transaction rate estimate was calculated.

FIG. 3 illustrates a graph 300 of the monthly transaction counts for a merchant (plot 302) compared to the estimate (plot 304) by transaction rate estimate systems 108 using the above techniques. As illustrated in plot 302 of graph 300, the monthly count of number of transactions tend to be noisy with a large variance from month to month. The noise in the transaction count over different time periods results may be smoothed out using the transaction rate estimate systems 108, as shown in graph 300. The corresponding graph of mean transaction rate (‘λ’ in the above equations) corresponds to the transaction estimate generated by transaction rate estimate systems 108. Plot 304 has a smoother curve than plot 302 and captures desired trends (e.g., early growth phase and a more recent drop in monthly transaction counts).

FIG. 4 illustrates a graph 400 to plotting transaction rate estimates highlighting the effect of the parameter ‘β’ (i.e., the forgetting factor). Each plot in has different values for β (i.e., 100, 1, and 0.1). (For reference, plot 304 in FIG. 3 was generated with transaction rate estimate systems 108 configured with β=1.). As shown in graph 400, in response to a large forgetting factor β the plot of rates tracks the raw transaction counts closely. Stated another way, the past history has very little effect on the current value for a large forgetting factor β In contrast, with a smaller forgetting factor β the rate takes a longer time to respond and hence the gradual curve. The forgetting factor β may be set on transaction rate estimate systems 108 to a predetermined value so that the sequence of rates is smooth enough to allow subsequent modelling, but not so smooth that it has lost characteristics present in the previous data and estimates. A suitable forgetting factor may be approximately 1 (i.e., 1+\−20%). Suitable forgetting factors may also range from 0.5 to 10, for example. The forgetting factor may be selected as any number greater than (or equal to) zero.

The above described estimation systems and processes use a Poisson-gamma conjugate prior pair, where the Poisson represented the rate λ in which the system is interested. In some situations, the other parametrization techniques may provide beneficial alternatives. For example, negative binomial—gamma conjugate prior pair may be a better choice for modeling some rates, with the primary advantage being realized in over-dispersed scenarios. That is, the mean and variance of a Poisson distribution is the same quantity, λ. So when the mean of a particular rate is expected to be much lower than the variance, the Poisson distribution may not mode the rate with the desired characteristics.

In contrast, the variance of a negative binomial with mean=λ has

$$variance = λ + \frac{{λ}^{2}}{r} ,$$

where ‘r’ is known as a dispersion parameter that controls how much larger than the mean the variance is. Note that by setting r as a number approaching infinity, transaction rate estimate systems 108 may recover the Poisson distribution from the negative binomial. In order to apply the negative binomial approach the dispersion parameter (r) may be estimated.

The transaction rate estimate system 108 uses the conjugate prior of the negative binomial, which is a beta distribution parameterized by two values (a & b) in equation 6.

(λ; a, b)=Beta (λ; a, b)

The mean and variance of a beta may be defined as:

$$μ = \frac{a}{a + b} and {σ}^{2} = \frac{ab}{{( a + b )}^{2} ( a + b + 1 )} . \qquad ( 7 )$$

Unlike in the case of a gamma where ‘a’ had the units “transactions” and ‘b’ had units “time”, in the case of a beta distribution, ‘a’ has units “successes” (i.e., times when a transaction happened) and ‘b’ has units “failures” (i.e., times when a transaction did not happen).

Given observations in the form of transaction events (e.g. c events in τ time periods), an updated rate can be obtained as follows (using an assumed dispersion rate ‘r’) in equations 8 through 10:

₀(λ; a₀, b₀)=Beta(λ; a₀, b₀)

₁(λ; a₁, b₁)=Beta(λ; â₀+c, \hat{b}₀+r*τ)

And as described above with reference to a Poisson distribution, so too here in the case of a beta distribution:

$${\hat{a}}_{0} = δ {a}_{0} , {\hat{b}}_{0} = δ {b}_{0} , δ = \frac{{σ}_{0}^{2}}{{σ}_{0}^{2} + β τ} \qquad ( 10 )$$

With the variance, σ₀², being the variance of the beta as given above. The β is a forgetting factor having a similar effect to the forgetting factor β as described above with reference to the Poisson distribution model. As a result, the recipe for an update is the same regardless of which conjugate prior pair is used. Thus, the immediately preceding beta distribution approach may be used in process 200 in place of the previously described Poisson distribution approach to generate and maintain estimates without having to maintain extensive historical data catalogues.

In various embodiments, transaction rate estimate system 108 may maintain an estimate of the transaction rate for every account holder and merchant combination. The estimate may be updated regularly using the steps described in process 200 above to ensure that all the latest transaction information has been consumed. For example, transaction rate estimate system 108 may run an estimate process similar to that of process 200 daily, weekly, monthly, or on other regular time intervals. Transaction rate estimate system 108 may also run an estimate process similar to that of process 200 in response to triggering events such as, for example, the completion of a previous run or a new transaction count exceeding a threshold value.

In various embodiments, transaction rate estimate system 108 may maintain the current {a, b} for an account holder and merchant combination. The update API call for such a system may then consume the counts for that given interval (i.e., event count c described above) and produces the updated values {á, \acute{b}} A corresponding read API call may return a/b as the current estimate of transaction rate to allow other systems to integrate and use the transaction rate estimates.

However, many account holders may not transact in a given interval, i.e., their corresponding c=0. And similarly, the fraction of merchants that see transactions within a short interval may be 0 or relatively small. A naive update process may loop over all merchants and account holders, regardless of whether they have had activity or not. A more complex system may be configured to only process those that have c>0 to increase speed and reduce the processing resources used by the system.

In various embodiments, transaction rate estimate system 108 may maintain a tuple {a, b, t}for every merchant and account holder combination. Here, the ‘t’ may be the timestamp of when the last c>0 observation was seen for this logical entity (i.e., a merchant and account holder combination in this example). The update call may produce the revised estimates {á, \acute{b}} as before, and the timestamp ‘t’ would overwrite the previous timestamp with the more recent time (reflecting the last seen transaction). The read call may take a timestamp as parameter T (i.e., equal to ‘current time’), and assumes that no transactions have been seen between the t & T, and may therefore return a rate estimate assuming that no transactions have been seen in the time interval [t, T].

Transaction rate estimate system 108 may be augmented to anticipate more complex scenarios. For example, transaction rate estimate system 108 may be configured with hierarchical rates in mind. Hierarchical rates may refer to scenarios where there is a notion of rates being inherited. For example, terminals and merchants may have a hierarchical rate given merchants may have points of sale, so transaction rate estimate systems 108 may estimate rates for individual terminals as well as at the merchant level. In another example, hierarchical rates may be generated for category spend for Account holders. A transaction account holder may have slightly varying spend behaviors in different categories, and may also have an overall spend rate.

The disclosure and claims do not describe only a particular outcome of estimating transaction rates, but the disclosure and claims include specific rules for implementing the outcome of estimating transaction rates and that render information into a specific format that is then used and applied to create the desired results of estimating transaction rates, as set forth in McRO, Inc. v. Bandai Namco Games America Inc. (Fed. Cir. case number 15-1080, Sep. 13, 2016). In other words, the outcome of estimating transaction rates can be performed by many different types of rules and combinations of rules, and this disclosure includes various embodiments with specific rules. While the absence of complete preemption may not guarantee that a claim is eligible, the disclosure does not sufficiently preempt the field of estimating transaction rates at all. The disclosure acts to narrow, confine, and otherwise tie down the disclosure so as not to cover the general abstract idea of just estimating transaction rates. Significantly, other systems and methods exist for estimating transaction rates, so it would be inappropriate to assert that the claimed invention preempts the field or monopolizes the basic tools of estimating transaction rates. In other words, the disclosure will not prevent others from estimating transaction rates, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber when their computer is offline. The system may include generating customized information about estimating transaction rates and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer conies online.

In various embodiments, the system and method may include a graphical user interface for dynamically relocating/rescaling obscured textual information about estimating transaction rates of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) relating to estimating transaction rates to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of estimating transaction rates, using a system for co-marketing the “look and feel” of the host web page with the product-related content information of an advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page; automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring* to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to transaction account may include any account that may be used to facilitate a financial transaction.

Phrases and terms similar to financial institution or transaction account provider may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to merchant, supplier or seller may include any entity that receives payment or other consideration. For example, a supplier may request payment for goods sold to a buyer who holds an account with a transaction account issuer.

A record of charge “ROC”) may comprise any transaction or transaction data. The ROC may be a unique identifier associated with a transaction. A transaction may, in various embodiments, be performed by a one or more members using a transaction account, such as a transaction account associated with a gift card, a debit card, a credit card, and the like. A ROC may, in addition, contain details such as location, merchant name or identifier, transaction amount, transaction date, account number, account security pin or code, account expiry date, and the like for the transaction.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc:), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter de⁻v⁻eloped, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system.. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols, If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein, See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction, Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.). MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a. series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression. SQL accessible, hashed via one or more keys, numeric, alphabetical by first tuple, etc.); Binary Large Object (BLOB); stored as ungrouped data elements encoded using ISO/TEC 7816-6 data elements; stored as ungrouped data elements encoded using ISO/TEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Two-fish, RSA, El Gamal, Schorr signature, DSA, PGP, PKI, GPG (GnuPG), and symmetric and asymmetric cryptosystems.

The computers discussed herein may provide a suitable API interface, website, or other Internet-based user interface which is accessible by users and/or interfacing programs. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix NlySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly &. Associates (1998); (3) “Cryptography & Network Security: Principles & Practice” by William Stallings, published by Prentice Hall; all of which are hereby incorporated by reference.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter wider 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Moreover, Where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(1) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
retrieving, by a transaction rate estimate system, a first transaction rate estimate;
retrieving, by the transaction rate estimate system, a new set of transaction data including a new transaction count and a new time period over which the new transaction count occurred;
estimating, by the transaction rate estimate system, a new transaction rate using a conjugate prior pair with the first transaction rate estimate, the new transaction count, and the new time period as inputs; and
storing, by the transaction rate estimate system, the new transaction rate.

2. The method of claim 1, wherein the conjugate prior pair comprises a Poisson-gamma conjugate prior pair.

3. The method of claim 1, wherein the conjugate prior pair comprises a negative binomial-beta conjugate prior pair.

4. The method of claim 1, further comprising:
generating, by the transaction rate estimate system, an initial transaction rate estimate;
retrieving, by the transaction rate estimate system, an initial set of transaction data over an initial time period; and
estimating, by the transaction rate estimate system, the first transaction rate estimate using the conjugate prior pair with the initial transaction rate estimate, the initial set of transaction data, and the initial time period as inputs.

5. The method of claim 1, further comprising discarding, by the transaction rate estimate system, the new set of transaction data in response to the estimating the new transaction rate.

6. The method of claim 1, wherein the transaction rate estimate system is configured to use the conjugate prior pair with a forgetting factor of approximately 1.

7. The method of claim 1, wherein the transaction rate estimate system is configured to use the conjugate prior pair with a forgetting factor ranging from 0.5 to 10.

8. The method of claim 1, further comprising:
estimating, by the transaction rate estimate system, a second new transaction rate using the conjugate prior pair with the new transaction rate_{;} a second new transaction count, and a second new time period as inputs; and
discarding, by the transaction rate estimate system, the new transaction rate in response to estimating the second new transaction rate.

9. A computer-based system, comprising:
a transaction rate estimate system processor;
a tangible, non-transitory memory configured to communicate with the processor, the tangible, non-transitory memory having instructions stored thereon that, in response to execution by the processor, cause a transaction rate estimate system to perform operations comprising:
retrieving, by the processor, a first transaction rate estimate;
retrieving, by the processor, a new set of transaction data including a new transaction count and a new time period over which the new transaction count occurred;
estimating, by the processor, a new transaction rate using a conjugate prior pair with the first transaction rate estimate, the new transaction count, and the new time period as inputs; and
storing, by the processor, the new transaction rate.

10. The computer-based system of claim 9, wherein the conjugate prior pair comprises a Poisson-gamma conjugate prior pair.

11. The computer-based system of claim 9, wherein the conjugate prior pair comprises a negative binomial-beta conjugate prior pair.

12. The computer-based system of claim 9, further comprising:
generating, by the processor, an initial transaction rate estimate;
retrieving, by the processor, an initial set of transaction data over an initial time period; and
estimating, by the processor, the first transaction rate estimate using the conjugate prior pair with the initial transaction rate estimate, the initial set of transaction data, and the initial time period as inputs.

13. The computer-based system of claim 9, further comprising discarding, by the processor, the new set of transaction data in response to the estimating the new transaction rate.

14. The computer-based system of claim 9, wherein the transaction rate estimate system is configured to use the conjugate prior pair with a forgetting factor of approximately 1.

15. The computer-based system of claim 9, wherein the transaction rate estimate system is configured to use the conjugate prior pair with a forgetting factor ranging from 0.5 to 10.

16. The computer-based system of claim 9, further comprising:
estimating, by the processor, a second new transaction rate using the conjugate prior pair with the new transaction rate, a second new transaction count, and a second new time period as inputs; and
discarding, by the processor, the new transaction rate in response to estimating the second new transaction rate.

17. An article of manufacture including a non-transitory, tangible computer readable storage medium having instructions stored thereon that, in response to execution by a transaction rate estimate system, cause the transaction rate estimate system to perform operations comprising:
retrieving, by the transaction rate estimate system, a first transaction rate estimate;
retrieving, by the transaction rate estimate system, a new set of transaction data including a new transaction count and a new time period over which the new transaction count occurred;
estimating, by the transaction rate estimate system, a new transaction rate using a conjugate prior pair with the first transaction rate estimate, the new transaction count, and the new time period as inputs; and
storing, by the transaction rate estimate system, the new transaction rate.

18. The article of claim 17, wherein the conjugate prior pair comprises at least one of a Poisson-gamma conjugate prior pair or a negative binomial-beta conjugate prior pair.

19. The article of claim 17, further comprising:
generating, by the transaction rate estimate system, an initial transaction rate estimate;
retrieving, by the transaction rate estimate system, an initial set of transaction data over an initial time period; and
estimating, by the transaction rate estimate system, the first transaction rate estimate using the conjugate prior pair with the initial transaction rate estimate, the initial set of transaction data, and the initial time period as inputs.

20. The article of claim 17, further comprising:
estimating, by the transaction rate estimate system, a second new transaction rate using the conjugate prior pair with the new transaction rate, a second new transaction count, and a second new time period as inputs; and
discarding, by the transaction rate estimate system, the new transaction rate in response to estimating the second new transaction rate.
